(19) United States
(12) Patent Application Publication
(10) Pub. No.: US 2022/0138797 A1
(43) Pub. Date: May 5, 2022

(54) CREATION AND DYNAMIC REVISION FOR AUDIO-BASED ADVERTISING

(71) Applicant: Wedel Software USA Inc., New York, NY (US)

(72) Inventors: Raoul Philippe Wedel, Leidschendam (NL); Timothy Paulissen, Leidschendam (NL); Franciscus Gerardus Kok, Leidschendam (NL)

(21) Appl. No.: 17/515,171

(22) Filed: Oct. 29, 2021

Related U.S. Application Data
(60) Provisional application No. 63/107,587, filed on Oct. 30, 2020.
(60) Provisional application No. 63/111,481, filed on Nov. 9, 2020.
(60) Provisional application No. 63/132,677, filed on Dec. 31, 2020.
(60) Provisional application No. 63/132,687, filed on Dec. 31, 2020.

(51) Int. Cl. G06Q 30/02; G10L 13/08

(52) U.S. Cl. CPC G06Q 30/0252; G06Q 30/0271; G10L 13/08; G06Q 30/0276; G06Q 30/0261; G06Q 30/0277

(57) ABSTRACT

A system and method for generating audio advertisement for websites, podcasts and radio stations etc. is disclosed. The invention includes software that allows advertisers an alternative method to generate such digital content (herein referred to as a ‘creatives’). Users log into a cloud network via a website where they have access to an online, multitrack editor that allows a user to select from a wide array of background soundtracks (e.g., music, special effects, and the like) and overlay them with new speech tracks. These speech tracks are created when a user types text into the speech processor. Users select from various types of pre-existing voice overs according to language, gender, and mood preferences, and the like. These tracks are combined to make a professional creative. An object of the invention is to allow advertisers to generate their own creatives without the assistance of costly promotional advertising agencies or expensive software.

### PRIORITY CLAIM

This application claims the benefit of U.S. Provisional Application No. 63/107,587, entitled “Creation and Dynamic Revision for Audio-Based Advertising,” filed Oct. 30, 2020, U.S. Provisional Application No. 63/111,481, entitled “Digital Advertising Server System for Radio Broadcasting,” filed Nov. 9, 2020, U.S. Provisional Application No. 63/132,677, entitled “Dynamic Cue Tone Creation for Radio Audio Advertisement Insertion,” filed Dec. 31, 2020, and U.S. Provisional Application No. 63/132,687, entitled “Audio Advertisement Insertion Using Finger Print Triggering,” filed Dec. 31, 2020, all of which are incorporated by reference in their entirety herein for all purposes.

### BACKGROUND

The first speech recognition systems can be traced back to 1952 when Bell Laboratories™ designed the “Audrey” system which could recognize a single voice speaking digits aloud. Ten years later, IBM™ introduced “Shoebox” which understood and responded to 16 words in English. Across the globe other nations developed hardware that could recognize sound and speech. And by the end of the '60s, the technology could support words with four vowels and nine consonants. Speech recognition also made several meaningful advancements in this decade. These advancements were mostly due to the US Department of Defense and DARPA. The Speech Understanding Research program they ran was one of the largest of its kind in the history of speech recognition. Carnegie Mellon's “Harpy’ speech system came from this program and was capable of understanding over 1,000 words which is about the same as a three-year-old's vocabulary. Also, significant in the '70s, was Bell Laboratories' introduction of a system that could interpret multiple voices. The 1980s saw speech recognition vocabulary go from a few hundred words to several thousand words. One of the breakthroughs came from a statistical method known as the “Hidden Markov Model”. Speech recognition was propelled forward in the 1990s in large part because of the personal computer. Faster processors made it possible for software like Dragon Dictate™ to become more widely used. BellSouth introduced the voice portal which was a dial-in interactive voice recognition system. This system gave birth to the myriad of phone tree systems that are still in existence today.

By the year 2001, speech recognition technology had achieved close to 80% accuracy. For most of the decade there weren't a lot of advancements until Google™ arrived with the launch of Google™ Voice Search. Because it was an app, this put speech recognition into the hands of millions of people. It was also significant because the processing power could be offloaded to its data centers. At the time Google's English Voice Search System included 230 billion words from user searches. In 2016, IBM™ achieved a word error rate of 6.9 percent. In 2017 Microsoft™ usurped IBM™ with a 5.9 percent claim. Shortly after that IBM™ improved their rate to 5.5 percent. However, it is Google™ that is claiming the lowest rate at 4.9 percent. Advertising has begun to take advantage of text-to-speech algorithms. United States Patent No. US20100086107A1 granted to Tzruya disclosed a text-to-speech system that allowed servers to analyze voice trends and offer tailored advertising based on the results. U.S. Pat. No. 9,563,62462 granted to Bangalore teaches of a text-to-speech system that translates advertising audio files into text. International Patent No. WO2011139848A3 granted to Google™ Inc. also disclosed a text-to-speech system that translates advertising audio files into text. U.S. Pat. No. 10,643,248 granted to Bharath et. al. appears to teach of a text-to-speech advertising system that automatically selecting pre-derived content based on information gleaned from the user based on an online profile. What is needed is a system that uses text-to-speech technology to allow users to generate creatives quickly and easily for both broadcast and streaming applications.

### BRIEF DESCRIPTION OF THE DRAWINGS

Embodiments of the subject matter disclosed herein in accordance with the present disclosure will be described with reference to the drawings, in which:

FIG. 1 shows a diagram of the novel approach in use on a mobile computing device according to an embodiment of the subject matter disclosed herein;

FIG. 2 shows a diagram of the novel approach in use on a desktop computing device according to an embodiment of the subject matter disclosed herein;

FIG. 3 shows the process operations in a computing environment of the novel approach according to an embodiment of the subject matter disclosed herein;

FIG. 4 shows an iteration of a graphical user interface according to an embodiment of the subject matter disclosed herein;

FIG. 5 shows another iteration of a graphical user interface according to an embodiment of the subject matter disclosed herein;

FIG. 6 shows another iteration of a graphical user interface according to an embodiment of the subject matter disclosed herein;

FIG. 7 shows another iteration of a graphical user interface according to an embodiment of the subject matter disclosed herein;

FIG. 8 shows a representative view of a conventional frequency sweep according to an embodiment of the subject matter disclosed herein;

FIG. 9 shows a method for enhancing cue tone recognition using existing cue tones according to an embodiment of the subject matter disclosed herein.

FIG. 10 is another algorithm for how the system may also be used in another embodiment to time the difference between audio and metadata received at an internet-based streaming server broadcast to address latency issues according to an embodiment of the subject matter disclosed herein;

FIG. 12 shows a representative of the hardware process that embodies the workflow of FIG. 11 according to an embodiment of the subject matter disclosed herein;

FIG. 13 shows an algorithmic method that embodies the workflow of FIG. 11 according to an embodiment of the subject matter disclosed herein;

FIG. 14 shows a representative view of a advertising trigger system according to an embodiment of the subject matter disclosed herein;

FIG. 15 shows a representative view of the fingerprint triggering method according to an embodiment of the subject matter disclosed herein; and

FIG. 16 is a diagram illustrating elements or components that may be present in a computer device or system configured to implement a method, process, function, or operation in accordance with an embodiment.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. These systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

By way of an overview, the systems and methods discussed herein may be directed to a solution to the shortcomings in the prior art through the disclosure of generating audio advertisement productions (e.g., creatives) for online streaming, podcasts, and radio stations. The novel approach includes an online system for generating audio segments for use in real-time broadcasting and online streaming audio content. A user may enter a text message into an online multitrack editor, and using text-to-voice technology, the editor will convert the text message into an audio message. The user may add background music and/or special effects to the message and may select one or more voice overs that will convey the message.

Further, the audio content may be enhanced and/or altered based on real-time triggers from third-party content providers. Thus, the novel approach may include selecting an incomplete creative (e.g., produced audio content), identifying a portion of the selected incomplete creative suited to have an insertion of content to render the creative complete, querying the remote user computer for additional identifying information about the desired advertisement. In response to answering the query, the system may retrieve textual data from a third-party computing system such as a sporting event update or a weather report. Then the system may convert the retrieved textual data into an audio file and then insert the audio file into the selected incomplete creative in the portion suited to have an insertion of content thereby generating a completed creative that includes the audio file.

According to embodiments discussed herein, such a novel approach greatly reduces time and resources needed for creating and producing adaptation of creatives. Further, this allows the development of creatives based on real-time triggers (e.g., events such as weather, sports games results, or news events). For example, a user may see a written account that a popular local rivalry game is about to take place. The user may copy and paste the event information text directly into a new creative and tailor the ad's theme around the event. Further yet, the novel approach allows for the mass production of locally tailored creatives. For example, for the presentation of a new car model, a single, national creative could be adapted to mention the name and address of a local auto dealership for hundreds of cities in a matter of minutes.

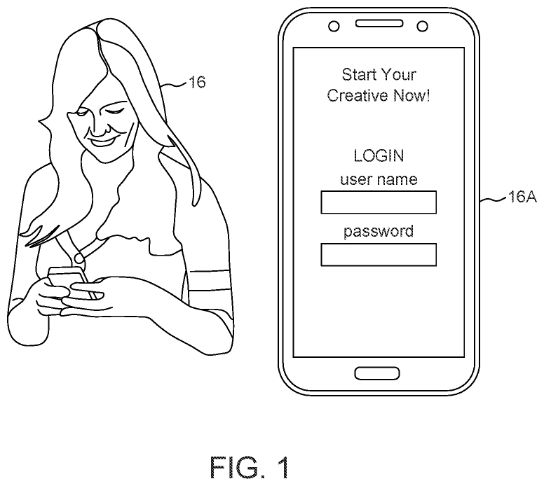

Additionally, another feature allows voice professionals (called voiceovers) to upload audio recordings of his or her voice. These voice-over files are used as a basis for the text to speech. The user can make a selection from hundreds of potential voice-overs. The advertisers may be charged based on the type and categories of voices that are available. The voiceover actor/actress may receive royalties when advertisers choose to use his or her voice. Alternatively for complex projects, a user may send a request for voiceovers to the selected voice actor/actress which can then upload the voice into the system. These and other aspects of the subject matter are more readily understood in the context and descriptions of FIGS. 1-16 in the following paragraphs.

### Creation and Dynamic Revision of Audio-Based Advertising

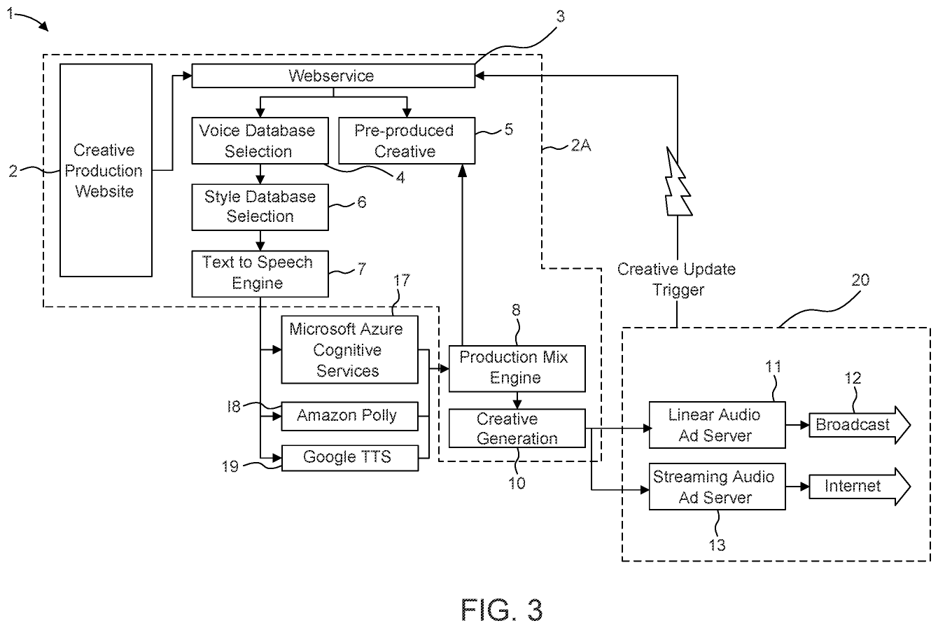

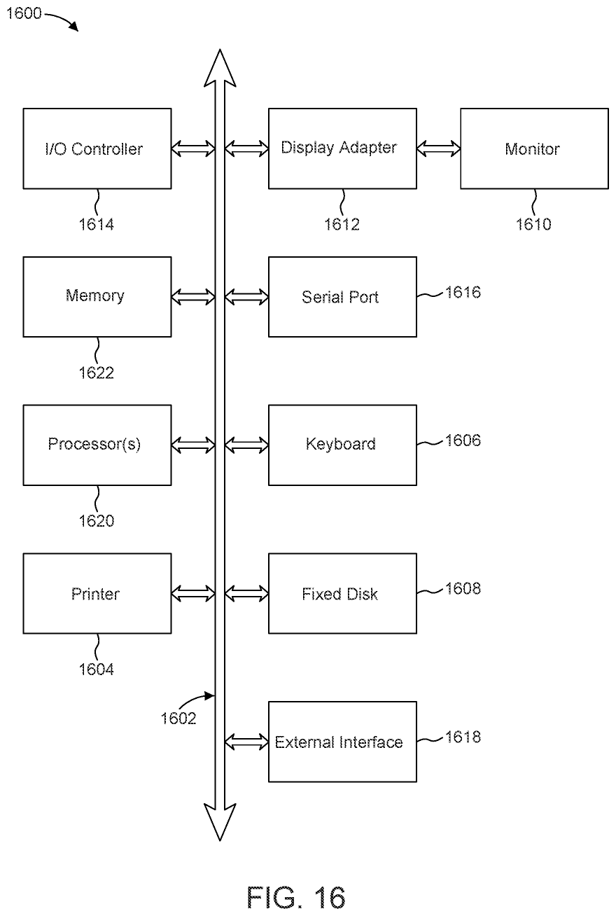

FIG. 1 shows a basic diagram for using the novel approach in use on a mobile computing device according to an embodiment of the subject matter disclosed herein. In FIG. 1, a human user 16 may be using a mobile computing device 16A (e.g., a cell phone, or the like) that is executing software embodying the novel approach to assembling creatives for use within the computing environment discussed below with respect to FIG. 3. The mobile computing device 16A may generally be a computing device as described below with respect to FIG. 16. As such, the user 16 may direct the executing software on the mobile computing device 16A to develop creatives.

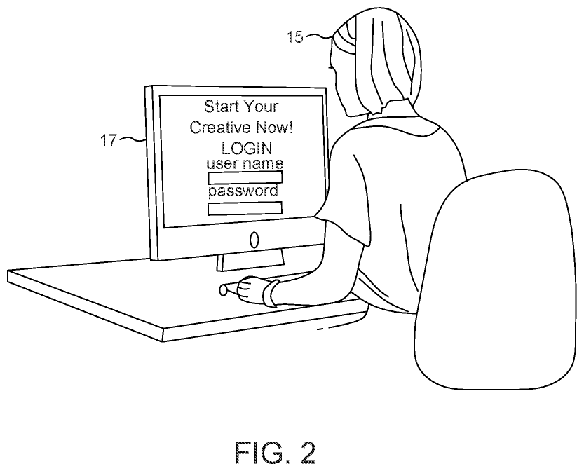

Similarly, FIG. 2 shows a diagram of the novel approach in use on a desktop computing device according to an embodiment of the subject matter disclosed herein. In FIG. 2, a human user 16 may be using a desktop computing device 17 that is executing software embodying the novel approach to assembling creatives for use within the computing environment discussed below with respect to FIG. 3. The desktop computing device 17 may generally be a computing device as described below with respect to FIG. 16. As such, the user 16 may direct the executing software on the desktop computing device 17 in conjunction with cloud-based executing software at remote server computers to develop creatives.

FIG. 3 shows the process operations in a computing environment/of the novel approach according to an embodiment of the subject matter disclosed herein. The computing blocks and devices shown in the computing environment/of FIG. 3 may be part of an overall computing system wherein a human user (15 of FIGS. 1 and 2) may utilize a local (e.g., remote from the computing environment of FIG. 3) to access these computing blocks and devices to carry out steps as discussed throughout this disclosure. A subset of the computing blocks and devices shown in the computing environment/of FIG. 3 may be embodied in one or more network server computers 2A as denoted by the dotted outline. The one or more network server computers 2A may include processors and memories (not shown) for executing computer-executable instructions for accomplishing the novel methods and approach as discussed next.

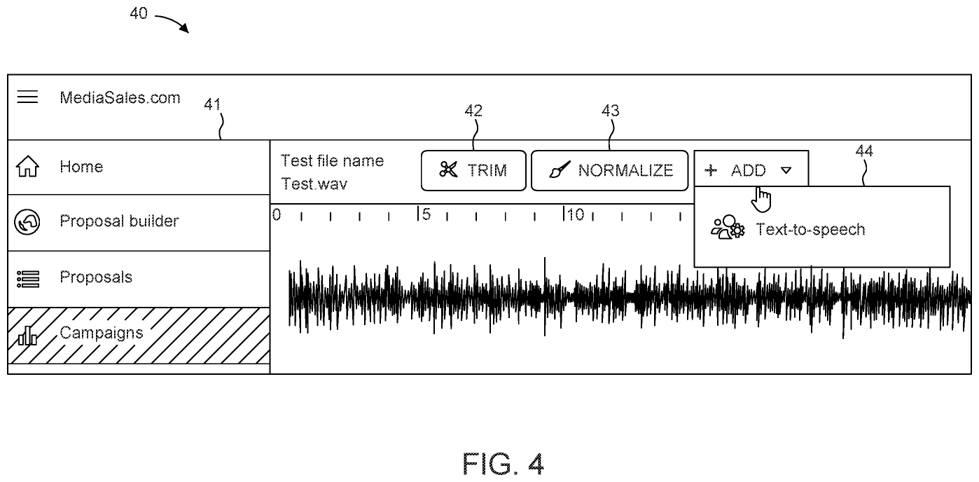

The software-based computing blocks and/or computing engines residing on the network servers 2A include a creative production website 2 (e.g., a website that allows users to login and make creatives as depicted on the computing devices of FIGS. 1 and 2. The network server 2A further include a web services block 3 that accomplishes back end operations (discussed below), a database of pre-produced creatives 5 (archive of digital audio backgrounds, music, sound effects and the like), a voice database 4 (voices in various languages, moods and the like), a dynamic dataset evaluation block 6, a text-to-speech engine 7, a production mix engine 8, and a creative file generation engine 10 (for assembling final creatives in various formats such as MP4, WAV, and the like). The text-to-speech engine 7 may utilize remote third-party services such as Microsoft™ Azure Cognitive Services 19; Amazon™ Polly 18; or Google™ TTS 19 for generating an accurate audio file of the text data that is input. Further, in FIG. 3, a resulting creative may be formatted for use in popular third-party services 30 such as Linear Audio Ad Servers 11 for broadcasting purposes and Streaming Audio Ad Servers 13 for overall internet-based purposes. Further, additional third-party services may be accessed to provide creative update triggers for dynamically altering and creating additional content in real-time in response to live events. As is discussed next with respect to FIGS. 4-7, references will be made to these figures as well as references back to FIG. 3 is discussing a workflow of the novel methods and approaches described herein.

FIG. 4 shows an iteration of a graphical user interface 40 according to an embodiment of the subject matter disclosed herein. In this depiction, a user interface 40 shows an online, multi-track audio editor having interactive functionality that includes a menu bar 41 (in which a user may select interfaces such as home, proposal builder, campaigns, and the like). The editor also includes audio editing features such as trim 42 and normalization 43 as well as an option for adding a text option for conversion into speech 44. With such an editor as a backdrop, a user may use a remote computer (e.g., mobile device 16A of FIG. 1) to browse to the creative production website 2. In an interactive and interactive manner, the user may navigate a process for building creatives quickly and efficiently using the creative generation web service 3.

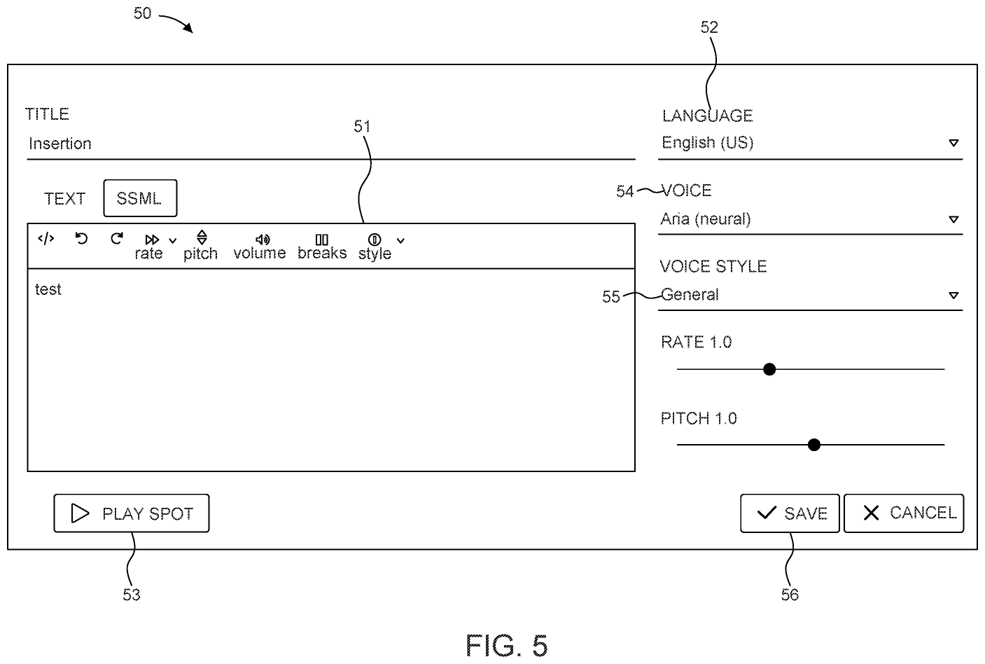

This user interface allows a user to select a creative for assembly and or/alteration from a database 5 of existing creatives that have either been previously produced (and may be in need of an update due to a triggering event) or may be one of several pre-produced creates having audio beds and carved out sections for additional audio (e.g., an incomplete creative). Once a creative is selected for completion or alteration, the editor may change to a different editing window as discussed next with respect to FIGS. 5-7.

FIG. 5 shows another iteration of a graphical user interface 50 according to an embodiment of the subject matter disclosed herein. This depiction may be shown once a user selects a specific creative to complete or alter (as selected from the database 5). This graphical user interface 50 provides control and functionality over common audio production tools typically embodied in a production mix engine 8 as shown in FIG. 3. This graphical user interface 50 depiction includes a text input window 51 whereupon a user may enter text desired to be converted into audio speech for use in conjunction with the selected creative. At any given time during an editing process, a user may engage a play spot button 53 to preview the entire audio of a current creative being edited. The user may also engage other typical audio editing features such as playback rate, pitch, volume, breaks, and style. The user may further engage additional editing features that may result in drop-down menu choices such as a language option 52 (which may include English, French, Spanish, German and the like), voices 54 (such as characters Aria, Guy, Benjamin, and the like), voice style (based on moods including but not limited to general, cheerful, and the like). The user may also, at any time during an editing session engage additional navigation function buttons such as save 56 and cancel. When save 56 is engaged, the current rendition of the creative may be stored back into the creative database 5.

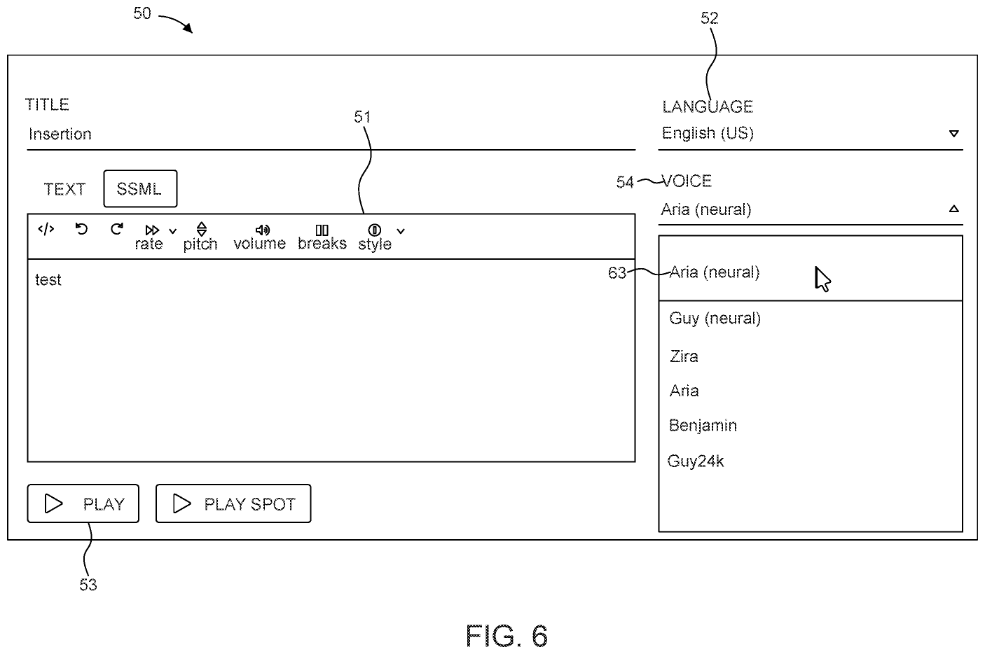

FIG. 6 shows another iteration of a graphical user interface 50 according to an embodiment of the subject matter disclosed herein. Here a user may select from voice database 4 having several different voicings from voiceover actors. As shown in the dropdown menu 63, a user may select a specific voice from the group including Aria (neural), Guy (neural), Zira, Ariel, Benjamin, and Guy24k. These and other voicing not shown may be selected by the user to alter the audio file returned from a third-party text-to-speech service (e.g., one services 17-19 in FIG. 3). In other embodiments, this selection is made prior to conversion so as to engage services offered by the third-party providers (e.g., the voice of a famous individual). Additionally, another feature allows voice professionals (called voiceovers) to upload audio recordings of his or her voice. These voice-over files are used as a basis for the text to speech. The user can make a selection from hundreds of potential voice-over files. The advertisers may be charged based on the type and categories of voices that are available. The voiceover actor/actress may receive royalties when advertisers choose to use his or her voice. Alternatively for complex projects, a user may send a request for voiceovers to the selected voice actor/actress which can then upload the voice into the system.

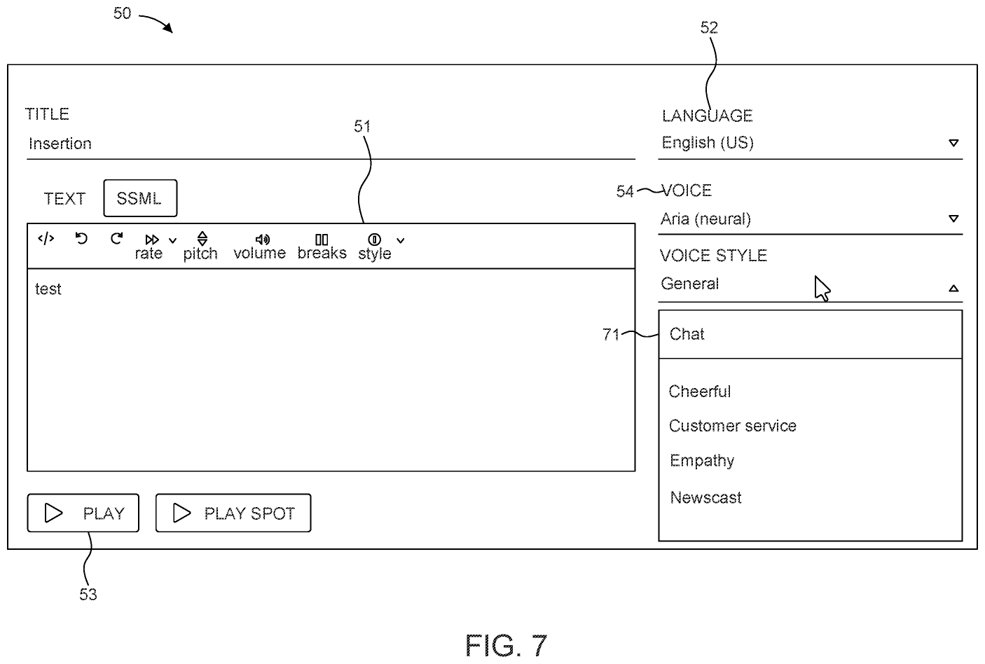

FIG. 7 shows another iteration of a graphical user interface 50 according to an embodiment of the subject matter disclosed herein. Here a user may select from voice style database 6 having several different voice stylings. As shown in the dropdown menu 71, a user may select a specific voice styles from the group including Chat, Cheerful, Customer Service, Empathy and Newscast. These and other voice stylings not shown may be selected by the user to alter the audio file returned from a third-party text-to-speech service (e.g., one services 17-19 in FIG. 3). In other embodiments, this selection is made prior to conversion so as to engage services offered by the third-party providers (e.g., the voice style of a famous individual).

Once the user is satisfied with the myriad options at disposal within the production mix engine 8, the user may again save the overall creative back to the creative database 5 and also may initiate rendering the creative into a desired audio format at the creative generation block 10. Such desired audio formats may typically include MP3 or WAV but may also be other audio formats like AAC, HE AAC, AacPlus, Ogg. The choice of format may depend upon where the rendered creative may be used (e.g., for broadcast or we stream.

### Digital Advertising Server System for Radio Broadcasting

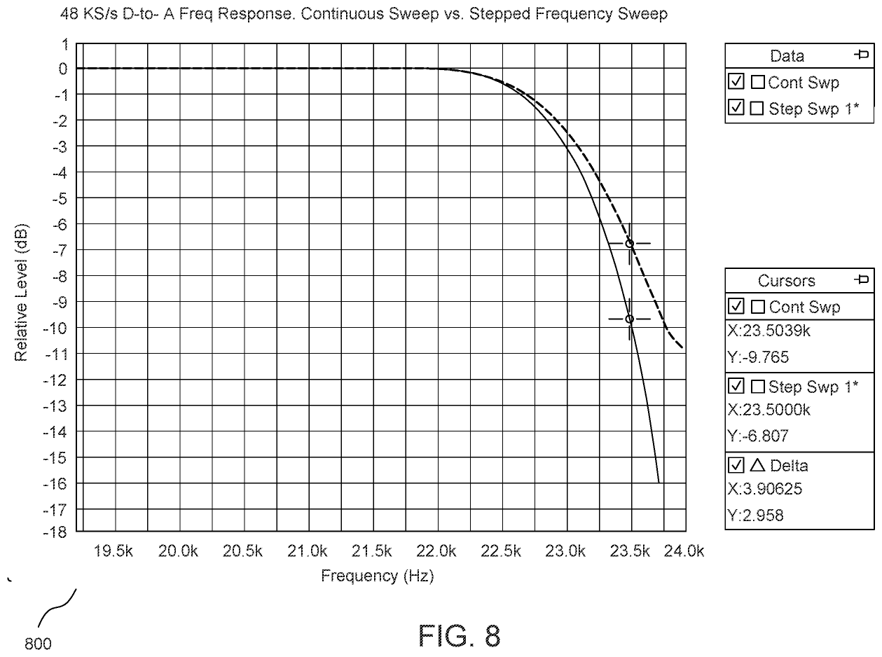

FIGS. 8-10 are directed to a digital advertisement server system for radio broadcasting. FIG. 8 shows a representative view of a sample of a typical frequency sweep 800 used by radio station broadcasters for use with the novel system and methods described below according to an embodiment of the subject matter disclosed herein. The depicted frequency sweep 800 is a tool used by broadcasters to continuously monitor incoming programming signals to decipher embedded cuetones that may be interpreted to insert ad segments therein, e.g., a roadmap for adding additional content into signal chains. A cue tone is a signal consisting of audio tones, used to prompt an action. In broadcast networks, a dual-tone multi-frequency signaling cue tone or sub-audible tone is conventionally used to prompt insertion of one or more local television commercial or radio advertisement by the broadcast automation equipment at the broadcast station or cable head end. In one known manner, audio tones at a specific fixed frequency are used to trigger events at a radio station such as ad replacement, news, and weather spots and the like. The accuracy of generation and recognition of such tones may vary depending on the equipment used at the radio station. Using high frequencies (e.g., frequencies above about 15 KHz) for these tones is preferred since they are not audible to the listening audience or able to reproduce in the audio signal that is broadcast. However, the higher the frequency of the tone, there is an increased risk that the radio station's equipment will consider such high frequency signals as undesirable and unintentionally filter out such tones causing ads not to be triggered and silence to be broadcast.

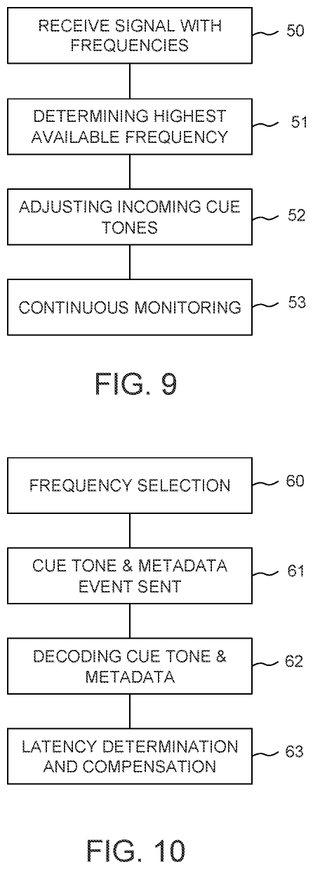

Internet-based, streaming broadcasting services can also have problems with incoming signals. Internet radio stations replace ads that are played in traditional broadcast by other ads during streaming. When replacing such ads, metadata is sent from the radio automation system in the studio to the streaming server. This metadata is sent asynchronously with the audio data. For this reason, the metadata may not arrive at exactly the same time as the audio data at the streaming server. This results in latency which may cause ads to be streamed at incorrect times with respect to programming. Radio stations typically measure this latency manually and compensate manually as a parameter in the context of a streaming provider's control panel (e.g., the latency is deciphered by a human and compensated for using streaming broadcast controls. The stream server then adjusts the audio and the metadata based on the manual setting. Changes in the audio processing or other equipment at the station or even changes at the Internet Service Provider of the radio station may change the latency, and thus result in an incorrect ad playing configuration. Radio station's staff is required to measure the latency regularly and make changes if required, What is needed is a software system that recognizes the highest frequencies available for cue tone detection and makes automatic adjustments in radio stations as well as recognizing latencies and making automatic adjustments in streaming stations to preserve ad spot integrity. Methods shown in FIGS. 9 and 10 that may utilize aspects of the system shown in FIG. 3 may address this need

FIG. 9 shows a method for enhancing cue tone recognition using existing cue tones according to an embodiment of the subject matter disclosed herein. Prior to discussing specific steps of the algorithm in FIG. 9, general aspects of the novel approach are discussed. A dynamic cue tone creation for radio audio advertisements (ads) is disclosed. The novel systems and methods comprise a software tool that determines a radio station's optimal available frequency for recognizing event trigger tones embedded in incoming broadcast material and adjusts incoming tones to match said available frequency. Such a software tool may be part of the network server 2A of FIG. 3. This dynamic matching allows a radio station to minimize unintentional filtering of ad triggers thereby enhancing ad play reliability. The dynamic cue tone algorithm may also be used in Internet streaming radio servers to address latency issues by identifying time differences between audio and metadata.

The device herein disclosed and described provides a solution to the shortcomings in the prior art the disclosure of a system and method for enhancing ad play reliability within traditional radio broadcast stations as well as internet streaming broadcasts. Additionally, the same may be used to recognize a traditional radio station's highest available frequency detection to avoid unintentional filtering of ad cue tones. Further yet, using the system, one may dynamically adjust incoming broadcast cue tones so that incoming broadcast cue tones can match available high tone cue detection capabilities at a traditional radio broadcasting station automatically. Still further, one may detect any differences between audio signals and the metadata received at an internet streaming server leading to automatically adjusting any detected latencies for internet-based streaming stations.

FIG. 9, thus, shows the algorithm that is compatible with a traditional radio station's existing program management software. The algorithm initially receives a signal having a range of audio frequencies therein at step 50. Then, the algorithm checks the station's highest, usable frequency by way of detecting what is available at the radio station at step 51. Once this frequency is determined (highest available), the algorithm then interacts with the incoming programming track and adjusts, at step 52, all ad cue tones to match the highest frequencies available at the station automatically and dynamically. That is, the incoming audio signal is altered where detected cue tones are changed into different frequency cue tones so as to be ensured of detection at the radio station. An audio ad server computer is placed in parallel at the radio station's radio automation computer system. The system also monitors (e.g., records) the final transmission of the radio station at step 53, after the sound processing equipment and any studio-transmitter links.

The algorithm may further include a process for iteratively determining the highest frequency detectable by the radio station equipment, this may be accomplished by sending tones at the highest possible frequency (generally, but not limited to 21 KHz for the ad server) in intervals of including but not limited to between 50-100 milliseconds. With each interval, the frequency is decreased by at least 500 Hz until a frequency of 12 KHz is reached. Generally, this frequency of 12 KHz will have a 0 db reduction while higher frequencies will have higher reductions. Based on the reduction in the higher frequencies, the maximum allowable frequency is chosen. One tone or a series of tones may then be chosen for triggering ad insertion events or other purposes as discussed above. The algorithm can be run daily or overnight at a radio station to keep track of any changes in the station's sound processing and to keep the effect to listeners to a minimum.

FIG. 10 is another algorithm for how the system may also be used in another embodiment to time the difference between audio and metadata received at an internet-based streaming server broadcast to address latency issues according to an embodiment of the subject matter disclosed herein. The dynamic cue tone algorithm is used to select the ideal frequency for cue tone generation in step 60. Once the ideal frequency is determined, a cue tone and metadata event are sent by the linear audio ad server at step 61. By having an encoder listening to the stream from the streaming server, the data from the stream may be decoded. At this stage, both the cue tone and the metadata are decoded from the stream in step 62. Once decoded, the difference in the time of arrival between the cue tone and the meta data can be determined and the latency is known. The linear audio ad server then can adjust the timing between the audio and the metadata so the metadata can arrive exactly at the same time at the streaming server. Because this can be set up as a continuous process, the algorithm can be set up to run at regular intervals like overnight, and the latency can automatically be adjusted at regular intervals at step 63. Because the system can be set up as a continuous process, the algorithm can be set up to run at regular intervals (such as overnight) and the latency can automatically be adjusted at regular intervals.

### Dynamic Cue Tone Creation for Radio Audio Advertisement Insertion

FIGS. 11-13 are directed to a digital advertisement server system for radio broadcasting that may feature dynamic cue tone creation for radio audio advertisement insertion. In an overview, the novel systems and methods of this aspect comprise a software tool that replaces audio advertisement functions from traditional automation software. The novel software also combines traffic and billing operations normally associated with independent, management system software packages. In a further embodiment, this novel approach allows radio stations to leverage more control over advertisement management functions such as editing content, scheduling content, improving integrations with digital ad servers, coordinating verification logs, and streamlining the reimbursement process.

In conventional broadcasting, traffic is referred to as the scheduling of program material, and in particular the advertisements, for the broadcast day. In a commercial radio or TV station there is a vital link between sales (of advertisement or commercial space) and traffic in keeping the information about commercial time availability. The station sells airtime to its customers. The traffic department together with sales aims to sell the available airtime (e.g., the “avails”) at the best possible rates. The traffic department generates a daily log of programming elements such as commercials, promotions, and public service announcements. The log defines when they are planned to be aired. The log is typically sent to a Radio Automation System that plays the commercials interspersed between programming content. A copy of the log after the fact is used for reconciliation to determine which advertisements actually aired and when.

Typically, a broadcaster uses a broadcast management software system that allows for automation between departments. Some software systems are end-to-end and manage the whole spectrum of tasks required to broadcast a television or radio station, others specialize in specific areas, such as sales, programming, traffic, or automation for master control. Salespeople usually start the process by making an agreement with a customer about a campaign. The agreement is called a sales order and it defines the dates when spots (advertisements) are run and the commercial terms of the campaign. At the station, a traffic person collects the sales orders and enters them into a computer system that will help to generate the daily logs. The traffic person also [symbol] the sales order with the possible media, such as an audio file which contains the recorded advertisement. When all the material is finished, the traffic system will be updated with parameters that define how the campaign will be run. What is needed is a software program that allows a station to have more control over advertisements and how they are played.

FIG. 11 shows a workflow of a radio station infrastructure according to an embodiment of the subject matter disclosed herein. Existing music logs 1101 enter the radio playout software 1102 while traffic logs 1104 enter the advertising playout 1105 and both sets of signals are ported into a proprietary virtual sound card file 1103 (shown as separate boxes in the workflow of FIG. 11). Here, the assimilated files are then mixed and transferred to a physical sound card or virtual audio over IP driver 1110 for broadcast distribution 1111. The triggers 1113 emanating from the ad playout are forwarded to existing digital ad servers 1121 along with materials 1120 for internet broadcasts 1122. FIG. 11 also illustrates a client application 1115 for live and studio use that includes start and stop breaks, count-down running breaks along with showing the time up upcoming breaks and their durations.

With such a workflow able to be implemented from systems as depicted in FIG. 3, a user/controller may enhance a radio station's broadcast technology infrastructure without relying on any analog sound cards and/or analog dual-tone, multi-frequency signals for advertising spot notifications as is conventionally done. Rather, it relies on a digital, operating platform driver file. The system accepts any radio traffic file format and is compatible across multiple operating systems. This upgrade minimizes hardware needs and converts a station to an all-digital advertising control program with less backups, less failure points and minimizes loss of audio quality since the solution is purely digital and does not rely on analog audio.

Additionally, this system provides a replacement audio driver for existing operating system platforms (such as Windows and the like). Conventional advertising systems for radio stations use a separate, physical, sound card. Audio from various sources inside a radio station (such as the Radio Automation System, Studio and Satellite programming) are mixed together into one system. Using a separate Audio Ad Server with the Radio Automation System usually requires additional hardware such as a sound card and mixer device to mix the Radio Automation System and the Audio Ad Server content. In addition, sound cards in computers are accompanied by a device driver for the operating system as mentioned. The current system includes a ‘replacement driver’ for the current sound card used by the Radio Automation System. By using this replacement driver, the various sources can be mixed on the computer in the digital domain, without the need for additional hardware.

Additionally, this system provides unified ad replacement for streaming servers. Replacing ads played by the radio automation system with linear audio ads today is a complex and cumbersome operation. The system will allow for zero-configuration integration with a streaming ad server. Because ad markers are usually delivered by only a single connection channel, factors such as poor internet connections, as well as distances between servers can generate latency. The system eliminates this latency and any resulting dead air space when ads are called up is minimized. The software significantly reduces latency in the sound by keeping the sound in the digital domain. In addition, the software also maintains file metadata that was previously lost in the transfer between typical traffic and automation systems and this carryover can allow stream servers to automatically call up companion adverts such as digital banners.

In another aspect, the system sends triggers to streaming web servers. Advertisements played on traditional radios stations are often replaced in the online stream variant of the program. Setting up those triggers is cumbersome. The triggers may not arrive at the streaming server in time due to latency issues. The invention discloses two methods of improving these triggers. First, a fingerprint of the commercial in the break is generated. The fingerprint is sent to the streaming server ahead of time. Once the streaming server recognizes the fingerprint, it can immediately replace the ad in the terrestrial radio program with a replacement ad in the digital program. Second, the audio stream is sent to the server by using an encoder. The encoder encodes audio data into an MP3 or other audio format like AAC, HE AAC, AacPlus, Ogg. By providing an alternative encoder, metadata may be encoded into the stream and may be inserted into the digital stream. This process is done by using a feature called ‘ancillary data’ that is a part of an audio file's DNA or stream called an ‘MPEG frame. By encoding the information on the advertisements directly into the MPEG stream, any latency issues become resolved. Once the stream with encoded data reaches the streaming server, the streaming server can then replace the ad based on the exact MPEG Frame, the DNA of the audio stream.

In another aspect, the advertisement server provides dynamic ad changing which allows for last-minute changes to audio advertisements (updating ad rotation carts in real time) and even campaigns. This feature makes it possible for the station to send live playlist and perform revisions to the playout. For example, a station has advertisement segments lined up for a super bowl game. Using the software, the system creates two ads, one version if, for example, the home team loses and one version if, for example, the home team wins. Dynamic changing allows for a specific advertisement be aired directly after the game depending on who wins (often referred to as making a good spot). An optional Traffic API can also make changes in existing logs. When a spot is missed in one commercial break, it can immediately schedule a make good spot in the next break. Another aspect of the advertisement server is to make local advertising insertions easier to manage. In addition, live changes can be conducted remotely through the embedded web server option.

Another aspect is to provide automatic cooperative ad reimbursement notifications known as ‘Coop ads’ in large advertising agreements normally segregated under existing traffic and billing software packages. Large product companies allow local resellers to be reimbursed for ads played on local radio stations. For example, a local car dealer is interested in playing the car manufacturer's ad on a local radio station. In these campaigns the radio station is required to send invoices with air times and scripts containing the text of the ad to a local dealer. The local dealer then asks for a reimbursement from the manufacturer. The invention allows for automatic invoicing with times and scripts and sends them to directly to the manufacturer for reimbursement.

Another aspect is to facilitate converting older, analog-based radio stations into a digital-based station. Replacing or upgrading an entire radio automation system requires training of all staff. Technical integrations must be performed to transfer existing files into the new traffic system and the music scheduling system—which all must be done simultaneously. Having an independent ad server based on a cloud network allows the owner to perform these changes in stages rather than disrupt the station.

Another aspect is to provide new forms of audio advertisement triggers. Start triggers include cue tones (the system recognizes a silent sound file with a cue tone); watermarks (the system recognizes pre-defined audio); apps; webservice; JSON; SOAP; GPIO; TCP; UDP; HTTP; telnet, axia, wheatstone, dhd, lawo, and ember+. Stop triggers include Silent file (System generates a silent audio file with the length of the break) apps; webservice; JSON; SOAP; GPIO; TCP; UDP; HTTP; telnet; axia; wheatstone; dhd; lawo; and ember+.

Another aspect is to provide novel audio features that include: a stitch mode (when no cues are available, the system generates one audio file with the break); a silence detector; off air monitoring; audio log of breaks; trimming; normalizing; stretch and pitch; and auto triggers for testing.

Another aspect is to perform automatic verification logs also normally segregated under existing management billing software packages. Once the radio automation system has played a file, it sends another log back to the radio traffic system called the verification log. The verification log is then imported into the radio traffic system automatically. The actual dates and times the spot played are then stamped on the digital invoice as proof of performance. This process streamlines reconciliation and auditing for accounting firms and publicly traded companies that must adhere to accounting standards such as the Sarbanes-Oxley Act (also known as SOX compliance). SOX compliance is a regulation that requires an audit trail to exist when any change is made in a system that has a financial impact. Optionally, the dates and times are sent back to a cloud-based Traffic API and made available on a website, removing the intervention of the (operator of) the Traffic and Billing System. The invention software is also compatible with a wide array of existing log file types. The system also enhances integrations between networks, representative firms, and booking houses.

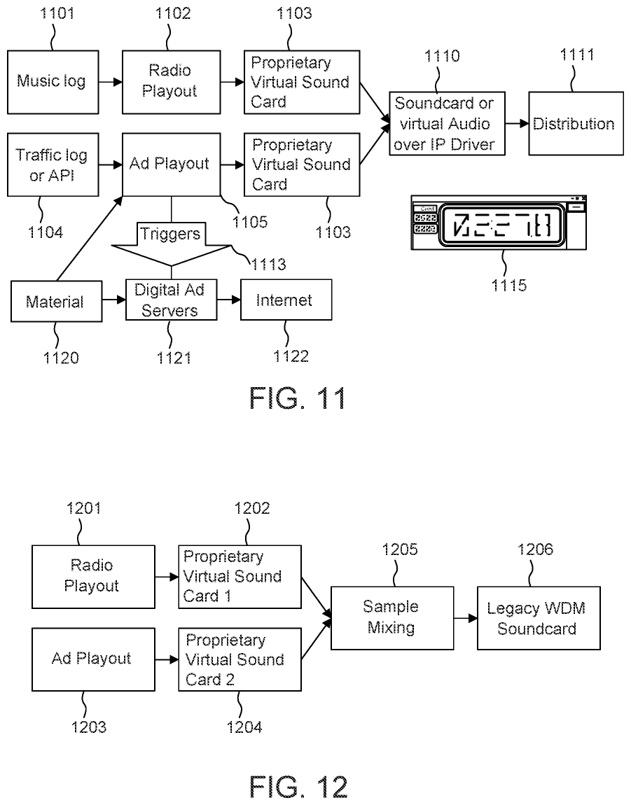

FIG. 12 shows a representative of the hardware process that embodies the workflow of FIG. 11 according to an embodiment of the subject matter disclosed herein. The hardware process includes radio playouts 1201 and ad playouts 1203 being transferred to a respective virtual sound card driver file 1202 and 1204. Then sample mixing takes place at a sample mixer 1205 such that a mixed audio signal may then be played on an existing, legacy sound card 1206.

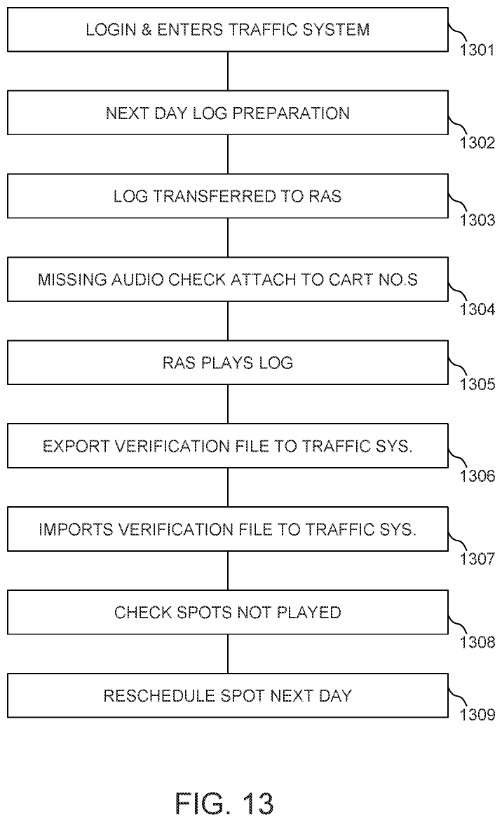

FIG. 13 shows an algorithmic method that embodies the workflow of FIG. 11 according to an embodiment of the subject matter disclosed herein. The method includes logging into the system and entering data into the traffic system at step 1301. The method continues in preparing future logs (i.e., next-day logs) at step 1302. Then, at step 1303, logs are transferred to the radio automation system. At step 1304, the method checks missing audio files and attaches the missing audio files to digital, numbered carts. With this backdrop in place, the radio automation system plays the current log at step 1305. The remaining steps of this algorithm in FIG. 13 include: exporting verification file to traffic systems at step 1306; importing verification files to traffic systems at step 1307; checking for spots not played at step 1308; and rescheduling spots for the future at step 1309.

The systems and methods herein disclosed with respect to FIGS. 11-13 provide a solution to the shortcomings in the prior art through the disclosure of a system and method for replacing advertisement functions in traditional radio automation software with a more robust, advertisement server system. Objects of this enhanced advertisement management system include improved integration through TCP/IP commands, latency trimming operations, full metadata integration, geo-targeting for traditional radio advertisers, companion advertisement generation and providing a single point for material management for both Radio Automation Systems and Streaming Ad Servers.

### Audio Advertisement Insertion Using Finger-Print Triggering

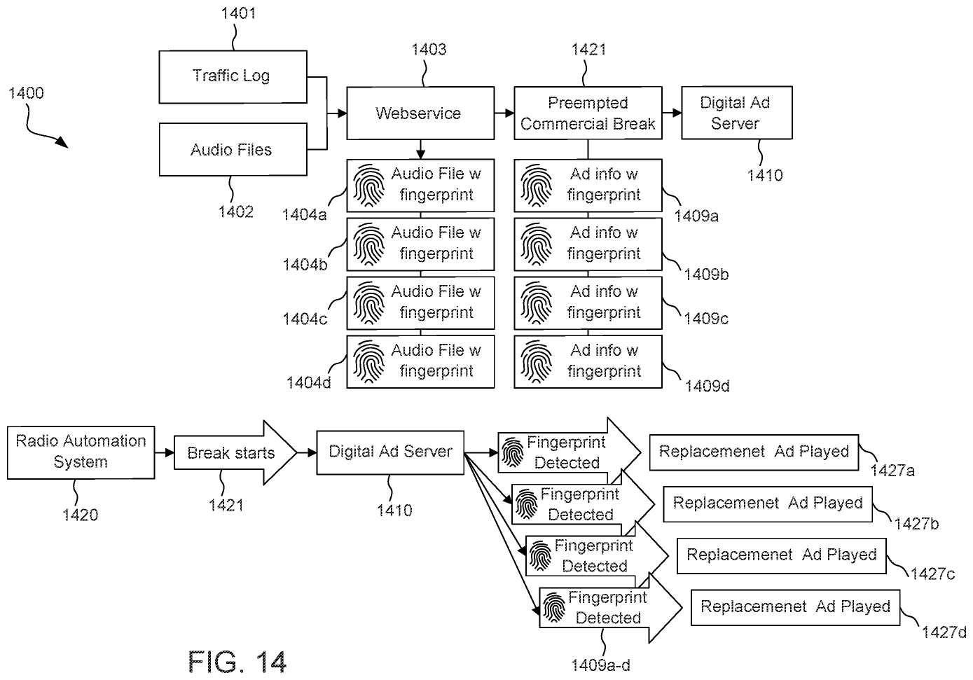

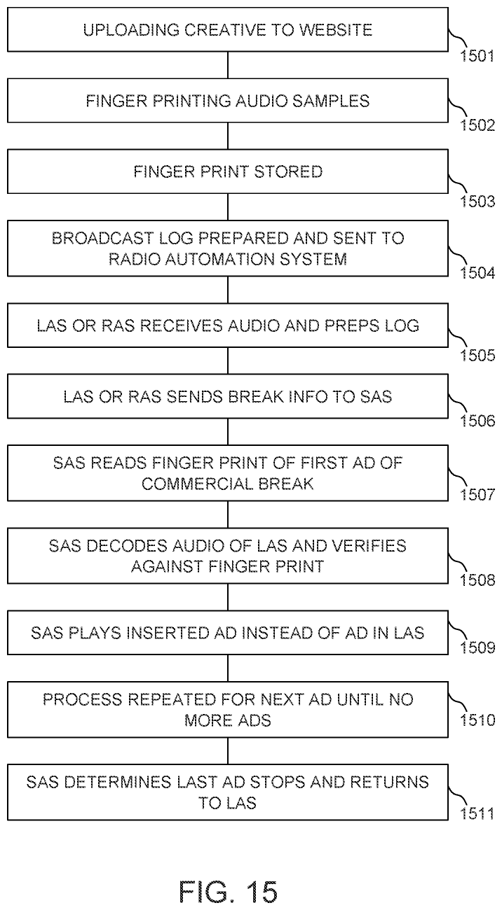

FIGS. 14-15 are directed to a digital advertisement server system for radio broadcasting that may feature audio advertisement insertion using fingerprint triggering. The systems shown in these FIGs. utilize a website that interacts with existing advertising servers and automatically replaces out-dated advertisement spots previously recorded on a linear audio program with new digital advertisements automatically. The system is based on a “finger printing” process that captures the first samples and meta data of the new creative file. These fingerprints are then used as triggers for starting local or in-stream insertion events for advertising servers. The systems and methods discussed herein enhance the accuracy and reliability of trigger advertisement insertion events into radio broadcasts.

Conventional radio station broadcasting uses dual-tone multi-frequency signaling (DTMF) which are changes in a tone's frequency to trigger local advertisement insertion events on linear advertising servers (Ad Servers). The DTMF Tones are encoded into a fixed-length audio file that is played by a Radio Automation System. The advertising server is connected to the Radio Automation system and ‘listens’ to the DTMF tone. Once the Ad Server receives the tone, it replaces the audio file played by the radio automation system with another advertisement. There are instances when this process can become unreliable for digital advertising servers. Since analog audio signals are encoded into a digital file, there is potential for error when decoding these triggers. For example, if a live disc jockey talks over the trigger, the trigger will not even be recognized. During this process there is no control over latency from the time it takes from when the tone is started, until the time the tone is detected by the advertising server. If the tone is detected too late, a small audible part of the original audio may be heard at the beginning of the break and be disruptive to the audience. Or, at the end of the break, the inserted audio may play too long and will be heard together with the same event causing further disruption. In more modern broadcasting system, radio automation systems and adverting servers use transmission control protocol/internet protocol commands to trigger advertising events. In this case, an event is placed in the playlist of a radio automation system that sends a command over the internet to an advertising server that triggers the playback of an inserted event or creative commercial break. Although generally there is a wide acceptance of this method by radio automation systems and ad servers, still not all radio automation and broadcast systems provide this option. While the chance of a missed or false trigger is lower, there are still latency issues which may result in late triggers. These issues specifically manifest themselves when the ad server replaces advertisements on a per-advertisement basis as to a per commercial break basis. Replacing each advertisement in a break requires more ads, more triggers and thus a greater chance of false triggers. What is needed is a more reliable system that can address false triggers and latency issues for radio broadcasters.

FIG. 14 shows a representative block diagram 1400 of an advertising trigger system according to an embodiment of the subject matter disclosed herein. Generally, all audio files 1402 that are played on a radio station are stored by a linear audio ad server or a media asset management system. The novel system consists of an application programming interface (API) 1403 (e.g., a web service) that can be called upon by the linear audio ad server 1410 or the radio automation system 1420. The log file 1401 with the advertisements to play is generated by an existing traffic system and it is ingested by the API 1403. By matching metadata in the traffic log 1401 to the audio files 1402, the system obtains the exact time duration of each file (in milliseconds) and a first setoff samples of the physical audio file. In digital audio, a sample is considered to be the smallest DNA portion of an audio file. For example, for CD Audio, a second of audio consist of 44.100 samples—this samples-per-second is also known as the sample rate. From the sample, a fingerprint is created 1404a-d. The fingerprint 1404a-d is used further down the broadcasting system chain to identify the start of a commercial break 1421 or an advertisement. The API 1403 then exposes the playlist data, runtimes of each file, and the sample fingerprint 1404a-d to the advertising server 1410.

Audio recognition is generally not a very quick or reliable way of recognizing audio, and therefore has never been used to successfully trigger insertion events. However, the combination with the above approach allows for a different approach. Audio recognition software systems currently available on the market like ‘Shazam’ or ‘Sound Hound’ are normally not connected directly to the digital source file itself, but rather these available services listen to the music over a microphone and record file contents. These audio recognition software applications use a vast library of songs. Using audio recognition for advertisements limit the number of fingerprints to on average of between 50-100 fingerprints per day on any given radio station.

In the current disclosure, the actual source of the audio file 1402 is used for fingerprinting, playback, and recognition—which makes it much more reliable. These recognitions can be accomplished for the content audio files 1404a-d or for the ad files 1409-a-d. The whole chain of fingerprinting, broadcasting, and recognizing the fingerprint remains in a seamless, digital domain 1410 and thus greatly reduces the time needed to recognize the fingerprint. The system pre-empts the scheduled time of the fingerprint to the advertising server. For example: an advertisement break 1421 is scheduled to start at 15:40 and starts with advertisement 1409a. Other breaks are scheduled at 15:10 and 16:00. Subsequently, the fingerprint for advertisement 1409a will be played between 15:10 and 16:00. Lastly, the system already knows that after advertisement 1409a is broadcast, the next advertisement is advertisement 1409b, which will be played at exactly a predetermined milliseconds after advertisement 1409a. The disclosure software creates triggers for audio commercials by creating a fingerprint of the first samples of the sound file. It uses the API 1403 to preempt content of commercial break with audio fingerprints and meta data. It also uses fingerprints as triggers for starting local or in-stream insertion events such as audio advertising insertion, in stream advertising insertion, and in-store advertising insertion. Companion advertising (e.g., displaying a banner when the audio advertisement plays, displaying a video commercial in the video stream when the audio ad plays) can include television advertisement insertion, advertisement insertion of events that are not fixed in duration, and can exempt certain ads from replacement (such as promos, PSAs, and Legal IDs). The device herein disclosed and described provides a solution to the shortcomings in the prior art through the disclosure of a system and method for replacing existing advertisement spots in linear audio programs automatically using a fingerprinting process. A goal is to present a more reliable system that can address false triggers and latency issues for radio broadcasters. The new system relies on a finger printing process that collects digital advertisement file metadata and sampling data beforehand to match existing advertising server breaks exactly to avoid such latency and false triggers from occurring.

A novel aspect realized from this system and method is to provide a system that allows for ad insertion of events that are not fixed in duration and also allows for the exemption of certain ads from replacement such as Promo's, PSA's Legal IDs. Another aspect is to enhance a radio station's broadcast technology infrastructure. The invention does not rely on analog sound cards and analog dual-tone, multi-frequency signals for advertising spot notifications such as many stations and systems do—instead it relies on a digital, operating platform driver file. The system accepts any radio traffic file format and is compatible across multiple operating systems. This upgrade minimizes hardware needs and converts a station to an all-digital advertising control program with less backups, less failure points and minimizes loss of audio quality since the solution is purely digital and does not rely on analog audio.

Another aspect is to provide a replacement audio driver for existing operating system platforms (such as Windows etc.). Traditional advertising systems for radio stations use a separate, physical, sound card. Audio from various sources inside a radio station (such as the Radio Automation System, Studio and Satellite programming) are mixed together into one system. Using a separate Audio Ad Server with the Radio Automation System usually requires additional hardware such as a sound card and mixer device to mix the Radio Automation System and the Audio Ad Server content. In addition, sound cards in computers are accompanied by a device driver for the operating system as mentioned. The current invention includes a ‘replacement driver’ for the current sound card used by the Radio Automation System. By using this replacement driver, the various sources can be mixed on the computer in the digital domain, without the need for additional hardware.

FIG. 15 shows a representative view of the fingerprint triggering method according to an embodiment of the subject matter disclosed herein. In this embodiment, the, the method includes the following steps. To begin with, the user uploads the creative into the API/Website at step 1501. Then the user directs the API to create the fingerprint for the first number of samples from the audio at step 1502. The fingerprint is stored in the system at step 1503. Next, the broadcast log is prepared and sent to the Radio Automation System (RAS) at step 1504. The Linear Audio Ad Server (LAS) or RAS receives the audio and prepares the log at step 1505. The LAS or RAS sends the information of the next upcoming break to the Streaming Ad Server (SAS) at step 1506. The SAS reads the fingerprint from the first ad of the preempted commercial break at step 1507. The SAS decodes the audio of the LAS program and verifies it against the fingerprint at step 1508. Once the fingerprint is recognized, the SAS starts playing the inserted ad instead of the ad in the LAS at step 1509. The ad plays and the process is repeated for the next ad, until there are no more ads at step 1510. The SAS knows from the Preempted Commercial Break exactly when the last ad is stopped and then returns to the LAS at step 1511.

FIG. 16 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. As an example, FIG. 16 is a diagram illustrating elements or components that may be present in a computer device or system 1600 configured to implement a method, process, function, or operation in accordance with an embodiment. The subsystems shown in FIG. 16 are interconnected via a system bus 1602. Additional subsystems include a printer 1604, a keyboard 1606, a fixed disk 1608, and a monitor 1610, which is coupled to a display adapter 1612. Peripherals and input/output (I/O) devices, which couple to an I/O controller 1614, can be connected to the computer system by any number of means known in the art, such as a serial port 1616. For example, the serial port 1616 or an external interface 1618 can be utilized to connect the computer device 16800 to further devices and/or systems not shown in FIG. 16 including a wide area network such as the Internet, a mouse input device, and/or a scanner. The interconnection via the system bus 1602 allows one or more processors 1620 to communicate with each subsystem and to control the execution of instructions that may be stored in a system memory 1622 and/or the fixed disk 1608, as well as the exchange of information between subsystems. The system memory 1622 and/or the fixed disk 1608 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Those skilled in the art will recognize that mobile applications are written in several languages include, by way of non-limiting examples, C, C++, C#, Objective-C, Java, JavaScript, Pascal, Object Pascal, Python, Ruby, VB.NET, WML, and XHL/HL with or without CSS, or combinations thereof. The app in invention 1 is also compatible with a plurality of operating systems such as, but not limited to: Windows, Apple, and Android, and compatible with a multitude of hardware platforms such as, but not limited to: personal desktops, laptops, tablets, smartphones, and the like. Suitable mobile application development environments are available from several sources. Commercially available development environments include, by way of non-limiting examples, AirplaySDK, alcheMo, Appcelerator, Celsius, Bedrock, Flash lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK Those of skill in the art will recognize that several commercial forums are available for distribution of mobile applications including, by way of non-limiting examples, Apple App Store, Google Play, Chrome Web Store, BlackBerry App World, App Store for Palm devices, App Catalog for webOS, Windows Marketplace for Mobile, Ovi Store for Nokia devices, Samsung Apps, and Nintendo DSiShop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe Flash Player, Microsoft Silverlight, and Apple QuickTime.

In view of the disclosure provided herein, those of skill in the art will recognize that several plug-in frameworks are available that enable development of plug-ins in various programming languages, including, by way of non-limiting examples, C++, Delphi, Java™, PHP, Python, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer, Mozilla Firefox, Google Chrome, Apple Safari, Opera Software Opera, and KDE Konquetor. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry Browser, Apple Safari, Palm Blazer, Palm WebOS Browser, Mozilla Firefox for mobile, Microsoft Internet Explorer Mobile, Amazon Kindle Basic Web, Nokia Browser, Opera Software Opera Mobile, and Sony PSP™ browser. Software Modules.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A computer-based method for generating an advertisement, comprising:
selecting an incomplete creative from a plurality of incomplete creatives stored in a data store at a server computer, the selecting caused by a user based upon a need for creating a desired advertisement from a remote user computer;
identifying, at the server computer, a portion of the selected incomplete creative suited to have an insertion of content to render the creative complete;
querying the remote user computer for additional identifying information about the desired advertisement;
in response to answering the query, retrieving, at the server computer, textual data from a third-party computing system, the textual data corresponding to the additional identifying information about the desired advertisement;
converting the retrieved textual data into an audio file;
inserting the audio file into the selected incomplete creative in the portion suited to have an insertion of content; and
generating a completed creative that includes the audio file.

2. The computer-based method of claim 1, wherein the additional identifying information further comprises location-based identifying information.

3. The computer-based method of claim 2, wherein the textual information corresponding to the additional identifying information further comprises an address associated with the location-based identifying information.

4. The computer-based method of claim 1, wherein additional identifying information further comprises weather-related identifying information.

5. The computer-based method of claim 4, wherein the textual information corresponding to the additional identifying information further comprises a weather forecast associated with the weather-related identifying information.

6. The computer-based method of claim 1, wherein additional identifying information further comprises identifying information corresponding to a sporting event.

7. The computer-based method of claim 6, wherein the textual information corresponding to the additional identifying information further comprises a sporting event update associated with the sporting event.

8. The computer-based method of claim 1, wherein additional identifying information further comprises identifying information corresponding to a newsworthy event.

9. The computer-based method of claim 8, wherein the textual information corresponding to the additional identifying information further comprises a news update associated with the newsworthy event.

10. The computer-based method of claim 1, wherein the portion suited to have an insertion of content comprises an audio bed without speech.

11. The computer-based method of claim 1, wherein the portion suited to have an insertion of content comprises a lack of any audio data.

12. The computer-based method of claim 1, wherein converting the retrieved textual data into an audio file further comprises engaging a text-to speech engine executing at the server computer.

13. The computer-based method of claim 12, further comprising:
querying the user for selecting one of a plurality of voice profile for use in the text-to-speech engine; and
in response to a user selection for one of the plurality of voice profiles; converting the textual data to the audio file using the selected voice profile.

14. The computer-based method of claim 1, wherein generating a completed creative further comprises generating a WAV file.

15. A computer system for generating creative based on user-selected variables, the computer system comprising:
a computer network configured to facilitate electronic communications between two or more computing devices;
a remote user computing device coupled to the computer network and configured to execute an application for directing generation of a creative;
a remote third-party computing device coupled to the computer network and configured to store a server computer coupled to the computer network and configured to execute a creative generation engine for:
selecting an incomplete creative from a plurality of incomplete creatives stored in a data store at a server computer, the selecting caused by a user based upon a need for creating a desired advertisement from a remote user computer;
identifying, at the server computer, a portion of the selected incomplete creative suited to have an insertion of content to render the creative complete;
querying the remote user computer for additional identifying information about the desired advertisement;
in response to answering the query, retrieving, at the server computer, textual data from a third-party computing system, the textual data corresponding to the additional identifying information about the desired advertisement;
converting the retrieved textual data into an audio file;
inserting the audio file into the selected incomplete creative in the portion suited to have an insertion of content; and
generating a completed creative that includes the audio file.

16. The computer system of claim 15, wherein the remote device comprises a mobile computing device.

17. The computer system of claim 15, wherein the remote third-party computer further comprises a computer configured to provide service and information regarding weather events.

18. The computer system of claim 15, wherein the remote third-party computer further comprises a computer configured to provide service and information regarding sports events.

19. The computer system of claim 15, wherein the server computer further comprises a radio automation system.

20. The computer system of claim 15, further comprising an audio recognition computer coupled to the computer network and configured to analyze audio and determine a fingerprint to be associated with the recognized audio for use in conjunction with a radio automation system.
